(19) United States
(12) Patent Application Publication
(10) Pub. No.: US 2002/0049081 A1
(43) Pub. Date: Apr. 25, 2002

(54) Electronic device holder

(76) Inventor: Jeffrey V. Heininger, Bellingham, WA (US)

Correspondence Address: BLACK LOWE & GRAHAM, 816 SECOND AVE., SEATTLE, WA, 98104, US

(21) Appl. No.: 09/999,642

(22) Filed: Oct. 19, 2001

Related U.S. Application Data
(60) Provisional application No. 60/242,568, filed on Oct. 23, 2000.

(51) Int. Cl. H04B 1/38

(52) U.S. Cl. 455/575; 455/90

(57) ABSTRACT

An electronic equipment holding device configured for holding any kind of cellular phone, navigational device, hand-held personal computer, digital recorder, or any similar portable device. The holding device comprises a base portion configured to fit within a standard cup holder, and a device retainer portion configured to retain the electronic device.

### PRIORITY CLAIM

This application claims the benefit of Provisional Applications 60/242,568 filed Oct. 23, 2001 which is hereby incorporated by reference.

### FIELD OF THE INVENTION

This invention relates generally to electronic equipment cradles, and more particularly to devices for holding any kind of cellular phone, navigational device, hand-held personal computer, digital recorder, or any similar portable device.

### BACKGROUND OF THE INVENTION

When cellular phones were first developed, they were bulky and were typically attached to a rigid mounting platform with an integrated power source that permanently mounted to the dashboard, floorboard, armrest, or glove box of the vehicle. Because cellular phones were often permanently mounted in cars, they were often called “car phones” instead of cellular phones. More recent models incorporate a one-piece design with a built-in power source allowing the user to easily transport the device. Most of these one-piece devices have a removable power cord used to recharge the batteries by plugging into a power source such as an automobile cigarette lighter.

Though cellular phones are no longer tethered to automobiles, they are still often used while driving. When using a cell phone in a car, it is both safer and more convenient to have the device centrally located within arm's reach. Even when using a “hands free” ear piece, a cellular phone is still saver and more convenient if it is restricted to a central location so that it cannot slide around, slip out of reach, or fall onto the floor while driving.

In the present state of the art, there are numerous holders for one-piece telephones. However, they are not suitable for accepting a wide variety of phones or other devices and require a permanent or semi-permanent method of mounting the holder to the vehicle. Existing telephone holders are also generally unable to hold the device while the power cord is plugged in and make it difficult to remove and use the device easily using one hand.

### SUMMARY OF THE INVENTION

The present invention is a holder for a wide variety of portable devices such as cell phones, global positioning system (GPS) receivers, digital recorders, personal computers, personal digital assistants, or any other hand-held device. The invention can removably fit into a cup-holder or similarly shaped cavity to transform a cup holder into an electronic device cradle.

In accordance with other aspects of this invention, the holder has an upward facing cavity that can securely hold a hand-held device, thereby providing a specific location for the device and eliminating any undesirable movement of the device while the vehicle is in motion.

In accordance with further aspects of the invention, the holder is preferably an integrally-molded one-piece unit.

In accordance with still other aspects of the invention, the holder can be quickly and easily removed from a car (or other location) and placed in another car, boat, or other desired location.

In accordance with yet other aspects of this invention, the holder will universally hold a wide variety of electronic devices, yet does so more snugly than existing cup holders or other carrying devices.

In accordance with still further aspects of this invention, in some embodiments the holder includes a shock dampening feature for protecting the portable device being held. Preferably, the shock dampening attribute is achieved through the use of shock absorbing materials or shaping the device in a manner that allows for shock absorbing flexure.

In accordance with other aspects of the invention, the holder includes a channel, guide, recess, clip, or other retainer for an electrical cord to enable the electronic device to be securely held while the power cord remains plugged in.

### BRIEF DESCRIPTION OF THE DRAWINGS

The preferred and alternative embodiments of the present invention are described in detail below with reference to the following drawings.

FIG. 1 is a perspective view of a device holder in accordance with the present invention;

FIG. 2 is a perspective view of an alternate embodiment of a device holder in accordance with the present invention; and

FIG. 3 is a perspective view of a device holder and removable insert cradle in accordance with the present invention.

### DETAILED DESCRIPTION OF THE PREFERRED EMBODIMENT

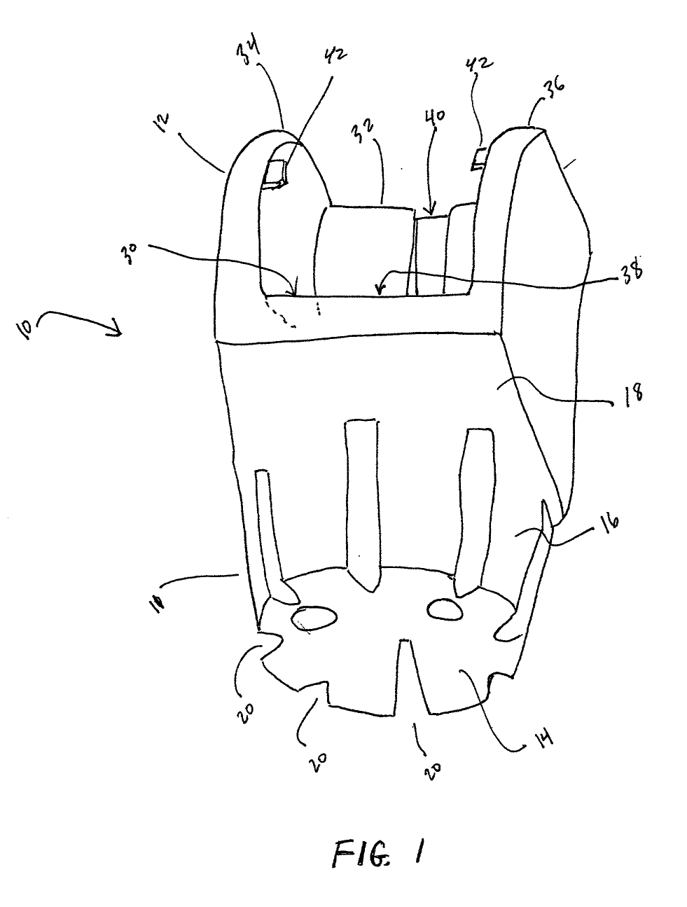

FIG. 1 illustrates a preferred embodiment of an electronic device holder in accordance with the present invention. The device holder is integrally formed as a one-piece unit and is capable of holding any of a variety of hand held devices. The device holder is designed to be mountable in a vehicle cup-holder or similarly shaped cavity.

The cup-holder is not illustrated and is not considered part of this invention. For the purpose of this invention, a cup-holder is defined as any device capable of holding a cup, thermos, or other beverage container. Typically, cup holders have a generally circular cavity defined by a circular bottom and a vertical or slightly outward-extending sidewall. A cup holder may also include a ring, arms, or loop instead of the side walls. In such constructions, cup holders may or may not include a bottom surface. Regardless of the particular construction, cup holders tend to be configured to receive and hold generally cylindrical containers.

The device holder 10 consists of a base or first end 11 and a device retainer or second end 12. In general, the first end 11 is configured to be received by a cup-holder while the second end 12 is configured to hold a cellular phone or other electronic device. Preferably, the device holder is integrally formed of solid plastic such as PVC that is at least somewhat flexible. Alternatively, it can be hollow or can be made from polyethylene foam or other materials.

The first end 11 includes a generally flat, circular bottom surface 14. A generally cylindrical side wall 16 extends axially upward from the bottom surface 14 to a radially-extending upper ledge 18. Preferably, the side wall 16 is inclined somewhat so that the circumference adjacent the upper ledge 18 is greater than that of the bottom surface 14. The inclined shape allows the first end 11 to fit within a cup-holder while also being frictionally retained by contact between the cup-holder and the side wall 16 at a point near the upper ledge 18. Alternatively, the side wall can form an upright cylinder or can be inclined in the opposite direction, so that the circumference of the first end is greater at the bottom surface 14 than it is adjacent the upper ledge 18. While the circular shape is preferred, the first end 11 alternatively may formed in any other cross-sectional shape, such as octagonal, hexagonal, square, oval, or others. Likewise, although the upper ledge 18 helps to restrain the device holder 10 from excessive downward movement into a cup-holder, the device holder 10 need not include an upper ledge consistent with this invention.

In an alternate embodiment, the side wall 16 of the first end 11 includes one or more relief areas to provide cost savings or other advantages. For example, a plurality of vertically-extending channels 20 may be formed in the side wall 18 to reduce the amount of material used. The channels 20 may also facilitate compression of the side wall 18 in order to allow the device holder 10 to fit into cup-holders that are slightly smaller in diameter than the diameter of the first end 11.

The second end 12 consists of four substantially vertical walls, including a forward wall 30, rear wall 32, and two opposing side walls 34, 36. The forward wall 30, rear wall 32, and side walls 34, 36 are preferably vertical (meaning parallel to a central axis extending from the first end to the second end), but may be inclined at a slight angle to create an opening that is somewhat larger than the size of the device platform 38. By flaring the walls out slightly, the electronic device may be more easily inserted and removed by the user.

The forward wall 30 is much shorter than the other walls, and serves as a lip to prevent the electronic device from sliding out while allowing the device to be easily inserted and removed. The lower height of the forward wall 30 also allows the user to easily see the device and any information being displayed on the face of the device. Alternatively, the forward wall 30 can be any height, including the same height as the surrounding walls.

The rearward wall 32 includes a slot 40 that is centrally located that extends axially from the bottom platform 38 to the top of the rear wall 32. The purpose of the slot is to allow a corded device to be quickly and easily inserted and removed from the device holder without removing the power cord. Thus, the slot 40 is shaped and sized to receive a power cord. Many alternate variations of the cord-retaining slot are possible. For example, in one alternate embodiment the slot extends fully through the rearward wall 40 to create a slit opening, rather than creating a channel as depicted in FIG. 1. In such an embodiment, the power cord for the cell phone or other device can extend through and out of the device holder 10. In yet other embodiments, the slot 40 is replaced by a clip to hold the cord in place.

The side walls 34, 36 contain retention tabs 42, preferably at the upper half of the side walls, that extend perpendicularly from the front edge of the side walls 34, 36 and parallel to the rearward wall 32. The purpose of the retention tabs 42 is to provide an additional restraint for the device being held and also to allow the device holder to accept a wider variety of models of hand-held devices while providing a snug and secure fit.

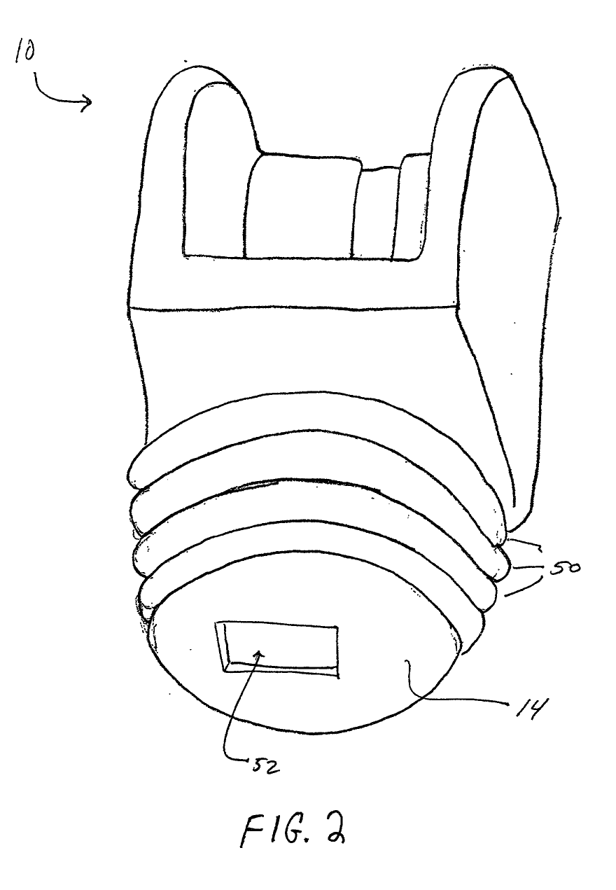

FIG. 2 illustrates an alternate embodiment of the present invention in which the vertical channels of the cup receptacle wall have been replaced with annular ribs 50. In this embodiment, any number of ribs 50 may be used to facilitate compression and frictional retention of the device holder 10 within a cup-holder.

In yet an alternate embodiment, the bottom surface 14 of the first end 11 includes a rectangular-shaped recessed area 52. The recessed area 52 is configured to accept a piece of double-sided adhesive tape so that the device holder 10 may be removably secured to any planar surface. Although the recessed area 52 is illustrated as included in the embodiment having annular ribs 50, it may be included (or excluded) in any embodiment of the present invention.

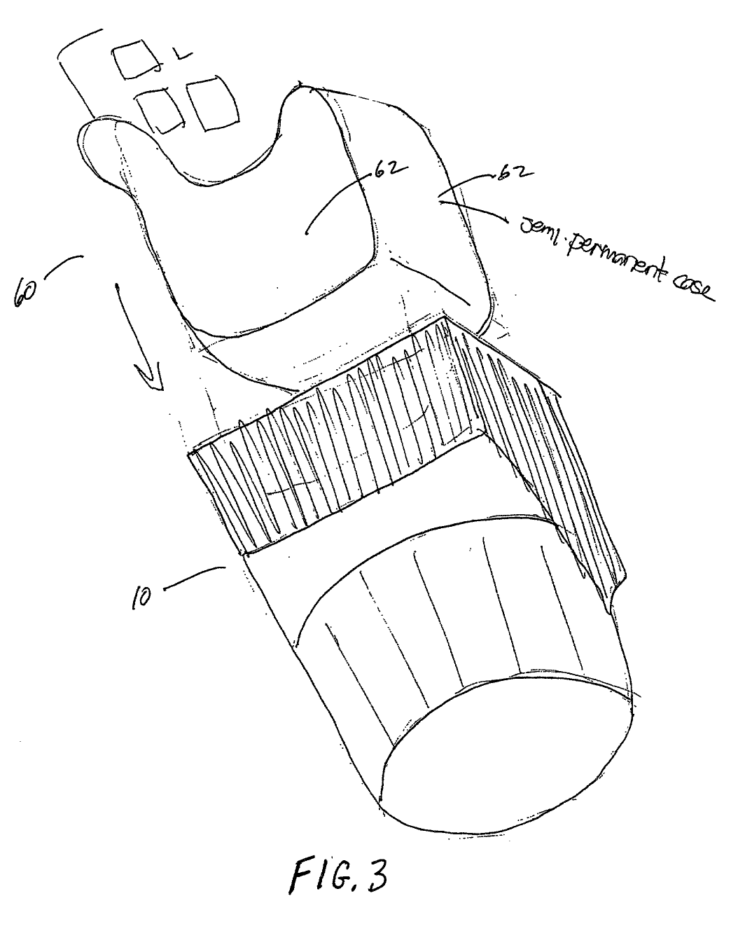

FIG. 3 shows another alternative of the device holder invention in which the shape of the second end of the device holder has been modified to accept an insert 60. In this alternate embodiment, the forward wall 30 is generally the same height as the rearward wall 32 and side walls 34, 36. Moreover, each of the vertical walls 30-36 may be somewhat shorter in this embodiment. The remaining attributes of the device holder are as described above, and includes a first end 11 suitable for insertion into a cup-holder.

The principal difference in this embodiment is that it uses an insert 60 that retains the electronic device and is retained within the device holder 10. The insert 60 is preferably constructed of a soft, shock absorbing material such as a low durometer plastic or rubber and may be specifically shaped to hold a particular brand or model of a hand-held device. Thus, the insert 60 includes an outer surface having four vertical walls configured to snugly fit within the interior cavity defined by the walls 30-36 of the device holder. The walls 62 of the insert 60 further extend upward to define an interior insert cavity that is specifically shaped to retain a particular electronic device. Accordingly, an unlimited number of inserts can be produced, each mating with a specific electronic device but each also fitting within the device holder 10 of the present invention. The insert 60 can be semi-permanently attached to the hand-held device and can be used as a protective case for the device even when it is not being used in conjunction with the device holder. The protective insert may be easily inserted into the second end of the device holder for use as described above.

While the preferred embodiment of the invention has been illustrated and described, as noted above, many changes can be made without departing from the spirit and scope of the invention. Accordingly, the scope of the invention is not limited by the disclosure of the preferred embodiment.

I claim:

1. A device holder, comprising:
a base portion; and
a device retainer portion connected to the base portion;
the base portion comprising a bottom surface and a base side wall extending from the bottom surface toward the device retainer portion; and
the device retainer portion comprising a bottom platform adjacent the base portion and a retainer side wall extending away from the bottom platform.

2. The device holder of claim 1, wherein the bottom surface of the base is generally circular in shape.

3. The device holder of claim 2, wherein the base side wall is inclined radially outward along a central axis defined from the bottom surface toward the retainer portion.

4. The device holder of claim 3, wherein the retainer side wall comprises a front wall, a rear wall, a first side wall, and a second side wall, each of the front wall, rear wall, first side wall, and second side wall extending away from the bottom platform.

5. The device holder of claim 4, wherein the front wall and rear wall are generally opposite one another, the first side wall is generally opposite the second side wall, and the front wall and rear wall are connected to each of the first side wall and second side wall to create a device-holding cavity.

6. The device holder of claim 5, wherein the front wall is shorter in length than the rear wall.

7. The device holder of claim 6, wherein the rear wall, first side wall, and second side wall are inclined radially outward along a central axis defined from the bottom surface toward the retainer portion.

8. The device holder of claim 7, wherein one of the rear wall, first side wall, or second side wall further comprises an axially-extending channel.

9. The device holder of claim 8, further comprising a first retainer tab connected to the first side wall and extending in a direction toward the second side wall, and a second retainer tab connected to the second side wall and extending in a direction toward the first side wall.

10. The device holder of claim 9, further comprising a channel extending substantially along the length of the base side wall.

11. The device holder of claim 9, wherein the base side wall further comprises a plurality of annular ribs.

12. The device holder of claim 9, wherein the bottom surface further comprises a recessed portion for receiving adhesive tape.

13. The device holder of claim 9, wherein the device holder is integrally-constructed as a single piece.

14. The device holder of claim 5, further comprising an insert configured to be received within the device-holding cavity, the insert comprising a floor and four upwardly-extending insert walls connected to the floor to define an insert cavity, wherein the insert cavity is adapted to retain a particular electronic device.

15. The device holder of claim 13, wherein the device is a cellular telephone.
